(19) United States
(12) Patent Application Publication
(10) Pub. No.: US 2007/0101065 A1
(43) Pub. Date: May 3, 2007

(54) Document storage system

(76) Inventor: James Stuart Walker, Warwick (GB)

Correspondence Address: GLENN PATENT GROUP, 3475 EDISON WAY, SUITE L, MENLO PARK, CA, 94025, US

(21) Appl. No.: 10/515,001

(22) PCT Filed: May 23, 2003
(86) PCT No.: PCT/GB03/02238

§ 371 Date: Jul. 25, 2005

(30) Foreign Application Priority Data
May 23, 2002 (GB) 0211874.3

(51) Int. Cl. G06F 12/00; G06Q 10/00

(52) U.S. Cl. 711/133; 711/159; 705/5

(57) ABSTRACT

A document storage system comprising at least one server (200) holding at least one electronic document. The system also comprises a document reception means arranged to receive an electronic document (300,302), a quality control means to facilitate quality control checks (304) of the electronic document, access means (106,108) to provide access to the server (200). Further, the system comprises a search means allowing an electronic document to be located and a terminal means (100) allowing users to connect to a server (200), locate an electronic document with the search means, and to receive that document. The system may be used to store electronic documents relating to hire vehicles.

### BACKGROUND OF THE INVENTION

This invention relates to a document storage system and related methods. In particular, but not exclusively, the invention relates to a system and method for providing the documents relating to the service history of rented commercial vehicles such as haulage trucks and refrigeration vans.

Presently, service documents relating to a vehicle, and in particular commercial vehicles, are generally stored in a paper format and are kept at an office local to the vehicle. These documents are kept to prove that the vehicle is being maintained to at least a minimum standard, showing that the vehicle is both road worthy and conforming to legal requirements. Should the vehicle be rented then the renter must be able to prove that the vehicle is road worthy and will therefore require access to the documents relating to the vehicle that they have rented. It is therefore desirable that these documents are readily available.

Vehicles, and commercial vehicles in particular, must be maintained relatively often and therefore documents appertaining to each maintenance must be locatable. The frequency with which the documents are produced increases the burden of keeping track of the necessary documents.

Further, it is not unknown for the location of a vehicle to change. For example, the office from which a vehicle is rented may change; it is not uncommon for a vehicle to be rented from a first site and returned to a second site. In such circumstances, the documents must be forwarded to the second site from the first, again increasing the burden to keep the documents in order.

A prior art system relating to tracking the service history of a vehicle belonging to a fleet of vehicles is disclosed in U.S. Pat. No. 6,308,120, in the name of Good. This document describes a system where data relating to the service history of a rented vehicle is entered manually—i.e. typed in—to an electronic system, for example on a data entry page on a computer.

U.S. patent application Ser. No. 09/933,005, in the name of Sasaki discloses a rental car reservation system. Data relating to a car required for hire is typed in to a data entry page. U.S. patent application Ser. No. 09/900,892, in the name of Tamai, discloses a system for providing the cars of individuals for hire. Again, data relating to a car required for hire is typed in to a data entry page.

The prior art discussed here makes no attempt to ease the burden of keeping track of and making available the necessary documents for maintaining a one or more vehicles.

### SUMMARY OF THE INVENTION

According to a first aspect of the invention there is provided a document storage system comprising:
at least one server on which at least one electronic document is held;
document reception means arranged to receive said electronic document and store said electronic document on said server;
quality control means facilitating quality control checks of said electronic document;
access means providing remote access to said server;
search means allowing said electronic document to be located on said server; and
terminal means allowing users to connect to said server using said access means, locate said electronic document using said search means, and receive said electronic document.

One advantage of such a system is that it allows copies of documents to be located centrally although the original document may not have been sent to a central location perhaps being located at a test centre, dealers or the like. This reduces the need to physically move documents reducing costs associated with postage and storage. The risk of damaging, losing or delaying the documents en route is also reduced, or possibly eliminated. When compared to an alternative possible system in which electronic documents are stored where the document is created and transmitting a copy to where it is required, the system could have the further advantage of reducing bandwidth requirements and saving time as the system according to the present invention would hold the documents centrally and there would be no need to repeatedly transmit the documents between sites. Further, the quality control means helps to ensure that the electronic document is of good quality and may be used to ensure that the electronic document meets one or more pre-determined criteria, some of which are legal requirements.

Further, the use of such a storage system may be advantageous to increase the ease of use for users of the system. It is likely that documents will be quicker and easier to locate. The long term quality of the stored documents may be increased. The costs and time associated with transferring documents to a relevant location may be reduced.

Preferably, the system is arranged to store electronic documents relating to vehicles, and most preferably in relation to vehicles that are intended to be hired and/or operated. An advantage of such a system related to vehicles is that, especially those that are hired, is that the physical documents do not need to be moved with the vehicle, as has been the case in the prior art. Trying to move a physical document with a rented vehicle is problematic, especially in environments such as haulage environments, etc., which are not suited for keeping paper documents.

The access means may provide access to a network, and in particular a WAN (Wide Area Network). Such an arrangement is convenient because it allows the terminal to be separated from the at least one server by considerable distances. As such it may be relatively easy to transmit a document over these distances, which may be more cost effective than prior art solution.

In a particularly advantageous embodiment the access means provides access to the Internet. Access to the Internet is advantageous because it is readily available and allows the electronic documents to be accessed from a large number of locations. In such an arrangement a terminal may be any suitable device for receiving data/information across the Internet. A particular advantage of this embodiment is that the terminal means will not usually have to be supplied with proprietary software to access documents stored on the system since software used to access the Internet is common. As such, the system will be able to be used by a large number of users with no modification to their computers or other Internet access device.

The, or each, server may be provided on a local network. The local network may be connected via a firewall to the Internet. Such an arrangement is convenient because it provides the convenience of providing a network of computers (increased speed of data manipulation by allowing access from a number of locations; increased security of data using network access restrictions; and the like.) whilst allowing restricted access to the network to the Internet via the firewall (thus helping to maintain data security).

Generally, the system comprises a plurality of servers. It will be appreciated that such an arrangement is advantageous at least because of the following reasons. Having a plurality of servers increases the available bandwidth for the electronic document to be sent to the access means; it increases the security of the electronic document (i.e. if any one server fails there is likely to be documents available from other servers); it reduces the necessary hardware specification for any one of the servers.

The document reception means may be capable of receiving faxes using known transmission protocols (for example G1, G2, G3, or G4 protocols). Such a document reception means is convenient because fax transmission is well known and widely available and therefore, the system will be able to receive documents from a large number of sources.

The document reception means may be arranged to send documents received thereby to the server without generating a paper, or other hardcopy. Such an arrangement is convenient because it reduces the amount of paper and helps to increase the quality of the electronic document stored on the server. The skilled person will appreciate that the more times a document is printed and converted into an electronic document the lower the quality of the electronic document.

Conveniently, the document reception means comprises a ZETAFAX™, which may be obtained from Equisys PLC., Equisys House, 32 Southwark, Bridge Rd., London, SE1 9EU.

In alternative, or additional, embodiments the document reception means may comprise a scanner, a photocopier, or the like.

The system may also comprise a scanner, in communication with said server, arranged to generate an electronic document for storage on said server. Such a system is convenient if a paper copy of the document is available and allows an electronic document to be placed on the server without the need for faxing the document to the system. The skilled person will appreciate that the scanner may be connected across a network to the server, may be connected to the server, may be connected to a computer connected to a network, or the like.

The system may also comprise a conversion means arranged to convert the electronic document received by the document reception means into a format suitable, or more suitable, for storing on the or each server. Such an arrangement is convenient because it can reduce, or indeed minimise, the storage requirements for storing the or each electronic document. Further, the conversion means may be arranged to resize any electronic documents which are not of a standard size to the standard size. This can be advantageous as it may reduce the need for specialised equipment for example equipment capable of printing on or copying A3 sized paper to produce or reproduce an A3 service sheet.

In one embodiment the conversion means converts the electronic document into Portable Document Format (PDF), which is the skilled person will appreciate is available from the ADOBE™ corporation.

In a preferred embodiment the electronic document stored on the or each server is write protected so that it requires a password to alter. Such an arrangement is convenient because it increases the security of the data held on the server. For example in the field of vehicle rental, a renter of a vehicle would be prevented from falsifying the paper or electrical document and as such the system may satisfy legal requirements that monitor use of the system for documents which have legal significance.

Conveniently, the quality control means comprises a display means which is arranged to display electronic documents received by the document reception means and/or the scanner.

The search means may be arranged to generate a list of electronic documents that are available for a given search input thereto. Such a list is advantageous because it provides a simple yet efficient manner in which to present the data to a user.

Further, the search means may be arranged to group the electronic documents within the list into sub-categories. Such an arrangement is convenient because it can speed the retrieval of the desired electronic document from the system.

In one embodiment the search means is arranged to have input thereto at least one identifier for a vehicle. The identifier for the vehicle may comprise a registration number associated with the vehicle for which it is desired to obtain the electronic document. This is advantageous as it reduces the information required by a user to access a document to a single item. In prior art systems, the user may have been required to know the location of the document, its date of issue, or other facts.

Alternatively, or additionally, the identifier may comprise an alternative indication of the identity of the vehicle, for example the company or fleet to which it belongs. Further, the identifier may include details of the data stored by a particular vehicle. For example it may comprise an indication of the software available on the vehicle. Such software may be provided to provide indication relating to mileage, fuel economy, present location, etc. of a vehicle. Examples of such software include Dynafleet™ and Fleetstar™.

The system may be arranged such that one or more passwords or other access restriction means is provided to restrict access to predetermined electronic documents. For example, one password may allow access to the server and a further password may allow access to records to all electronic documents in a predetermined sub set of the documents stored, or indeed each electronic document may be protected. In one embodiment, a sub set of the electronic documents held may be provided for a fleet of vehicles, perhaps relating to a particular company, etc.

The system may comprise a diary means arranged to maintain a record of when predetermined events occur. Such an arrangement is convenient because it allows events to be monitored.

Conveniently, the diary means is arranged to hold information regarding when machinery must be serviced, tested, and the like. The machinery may include vehicles, as well as components for vehicles such as lift hoists, fridge motors and the like, as well as potentially any other machinery. It will be appreciated that such servicing and testing are legal requirements for vehicles and components thereof such as refrigeration units and tail lift motors and in particular trucks, and as such it is important that such events are not missed. Such a method may be able to provide for greater certainty and user convenience in meeting such legal requirements.

The system may comprise at least one database means, which is arranged to record the or each electronic document stored on the system. Such a database means facilitates retrieval of the document and reduces the amount of time taken to locate the electronic document by the search means. The database means may reduce the amount of storage needed to store the electronic document by arranging them in an efficient manner on the or each server.

The system may advantageously comprise a plurality if database means. This may be useful when the system is used to control several fleets, categories of vehicle and/or the fleet of several companies. Details of one fleet or company could be contained in its own database. This reduces the need to search through all the documents when it is known that details of a vehicle belonging to a particular fleet, category and/or company are required.

The method may provide a web site associated with each database means such that that web site may be accessed to access the data held in that database means. Such an arrangement may make it convenient to provide access to sub sets of the overall data (for example of the vehicles belonging to a particular fleet). In additional, or alternative embodiments two or more web sites may be arranged to access the data held in a single database means.

Preferably, the database means and the diary means are interfaced to one another. Interfacing the database and diary means in this manner provides a convenient system to use: data is transferred between the two systems more conveniently; accuracy of the data is improved; the data in the system becomes more accountable and easier to analyse. However, the security of the data may be improved; data within the diary means is separated from that in the database means.

Further, interfacing the database means and the diary means may allow feedback when an expected event, such as a service, does not occur by a date held in the diary means (i.e. when a document relating to the expected event is not received within a given time period following the event). An alert or report may then be generated.

Indeed, the diary means may be arranged to generate reports as to machinery that has not met its servicing requirements. Such an arrangement is advantageous because it can help to alert the owner and/or user of the machinery that machinery may not be legal. Such a diary means may be thought of as providing a closed loop that allows a user of the system to ensure that the machinery that they operate has been fully serviced, perhaps as required by the law.

The system may be further arranged to delete and/or archive electronic documents that have reached a predetermined age. The predetermined age may vary according to the content of the electronic document. For example, if a vehicle is serviced every six weeks then the system may be arranged to delete the electronic document after six weeks. The skilled person will appreciate that the electronic document may be a graphical representation of the original document. If this is the case this arrangement is particularly advantageous due the size of the file on the server that is required to hold the electronic document. Deleting the electronic document once it has reached the predetermined age provides the technical advantage of reducing the space required to store the electronic documents. Further, it will be appreciated that as the amount of storage space is reduced, it is likely that search and retrieval times are also reduced.

The diary means may be arranged to determine when the electronic document has reached the predetermined age.

The database means may be arranged to generate and/or maintain a link to the electronic document stored on the or each server. The system may be arranged to present a user with a list of such links, and further arranged such that activation a link provides the user with the electronic document.

Conveniently, the links provide a network address from which the electronic document can be obtained. The server may be arranged to communicate using any known protocol. For example any of the following may be suitable: http, https, ftp, xpath, or the like may all be suitable.

The system may be arranged to generate pages viewable on the network in use as the page is required and in particular the system may be arranged to generate html, xml, or the like.

The document reception means may be arranged to add the time and/or date at which a document is received by the system either to the database means and/or the document itself. Such a method is convenient because it helps to increase the accountability of the documents held in the database means.

According to a second aspect of the invention there is provided a method of storing at least one electronic document, said method comprising receiving said electronic document using a document reception means; checking the quality of the received electronic document using a quality control means; storing said electronic document on at least one server; allowing said electronic document to be located on said server, by users of terminal means connected to said server via an access means and using a search means, provided to facilitate the location of said electronic document.

Preferably, the method provides a method of storing documents related to vehicles and in particular to vehicles that may be hired. Alternatively or additionally, the system may relate to any fleet of vehicles such as light and heavy commercial vehicles, cars, heavy plant, buses, coaches, etc.

According to a third aspect of the invention there is provided a server suitable for use in the invention according to the first aspect of the invention and being arranged to store at least one electronic document thereon; said server being provided with a means to receive said electronic document for storage thereon; said server further comprising access means providing access to said electronic document thereon from a remote source; said server further comprising a search means, or providing access to a search means, which facilitates the location of said electronic document.

The server of the third aspect of the invention, or indeed any of the other aspects of the invention, may be arranged to hold details relating to any of the following: light and heavy commercial vehicles; cars; heavy plant; PSV's or any other vehicle, or machinery that is legislatively required to meet regular test requirements.

According to a fourth aspect of the invention there is provided a terminal means suitable for accessing a server according to a third aspect of the invention and receiving electronic documents from said server.

According to a fifth aspect of the invention there is provided a system arranged to store at least one document, said system comprising:
one or more servers on which at least one electronic document is held;
a document reception means, capable of receiving a facsimile transmission and, arranged to receive said electronic document via a facsimile transmission and store said electronic document on said server
a quality control means facilitating quality control checks of said electronic document;
access means providing remote access to said server;
a search means arranged to facilitate location of said electronic document on said server, said search means locating any electronic documents relating to a vehicle specified to said search means stored on the or each server;
terminal means arranged to connect to said server using said access means, and further arranged to receive a list of electronic documents relating to the vehicle specified to the search means;
selection means allowing a user to select one or more electronic documents said list, and the system further being arranged for said terminal means to display said electronic document selected by said selection means.

The system is preferably arranged to store documents relating to one or more vehicles. Such a system may be thought of as providing a tool for managing a vehicle, a generally a fleet of vehicles.

According to an sixth aspect of the invention there is provided a method of storing at least one document, said method comprising:
receiving an electronic document using a document reception means provided capable of receiving a facsimile transmission;
checking the quality of the received electronic document using a quality control means;
storing said electronic document on one or more servers;
providing a search means to facilitate location of said electronic document on said server, said search means locating any electronic documents relating to a vehicle specified to said search means stored on the or each server;
providing an access means allowing users of terminal means to access said server;
said search means providing a list of electronic documents relating to the vehicle specified to the search means, to the user, such that the user can select one or more documents from the list, to generate one or more selected electronic documents, and receive said selected electronic documents.

The method may store documents that relate to one or more vehicles.

According to a seventh aspect of the invention there is provided a vehicle document storage and retrieval system arranged to maintain a store of electronic documents relating to a vehicle, said system comprising a memory arranged to hold the electronic documents, a document reception means arranged to receive electronic documents and store them in said memory, access means allowing a user remote access to the memory, search means allowing a user to locate an electronic document and at least one terminal means allowing a user to access the memory using said access means, locate an electronic document using the search means and receive the electronic document on the terminal means.

According to a eighth aspect of the invention there is provided a computer program arranged to maintain a database means of electronic documents, receive further electronic documents from a document reception means and store the received documents in the database means, provide a quality control check of the document using a quality control means, provide remote access to the database means and allow users to search the database means to locate electronic documents therein and forward them to the user.

According to an ninth aspect of the invention there is provided a computer program providing a vehicle document storage and retrieval system and arranged to maintain a database means of electronic documents, receive further electronic documents from a document reception means and store the received documents in the database means, provide a quality control check of the document using a quality control means, provide remote access to the database means and allow users to search the database means to locate electronic documents therein and forward them to the user.

The skilled person will appreciate that any of the features discussed in relation to the first aspect of the invention may be applicable to any of the other aspects of the invention.

According to a tenth aspect of the invention there is provided a database comprising a plurality of electronic documents relating to a vehicle, each document being password protected in order to prevent alteration thereof, and the database further comprising a diary means arranged to maintain a record of when predetermined events are due to occur to the vehicle to which the electronic document relates and also maintain a record of when the event actually occurs.

Such a database is convenient because the electronic documents may be suitable for satisfying legal requirements since they are unalterable unless a password is used. Further, the diary means may be used in order to check the details of that the predetermined events did actually occur as scheduled. Such checking is useful in order to satisfy legal requirements, which are relevant in fields such as running one or more vehicles.

According to a eleventh aspect of the invention there is provided a machine readable medium containing instructions which when read onto a computer cause that computer to provide the system of any of the first, fifth or seventh aspects of the invention.

According to a twelfth aspect of the invention there is provided a machine readable medium containing instructions which when read onto a computer cause that computer to perform the method of the second or sixth aspects of the invention.

According to a thirteenth aspect of the invention there is provided a machine readable medium containing instructions which when read onto a computer cause that computer to function as the server of the third aspect of the invention.

According to a fourteenth aspect of the invention there is provided a machine readable medium containing instructions which when read on a computer cause that computer to function as the terminal of the fourth aspect of the invention.

According to a fifteenth aspect of the invention there is provided a machine readable medium containing instructions that provide the program of the eighth of ninth aspects of the invention.

According to a sixteenth aspect of the invention there is provided a machine readable medium containing instructions that provide the database of the tenth aspect of the invention.

The machine readable medium of any aspect of the invention may be any one or more of the following: a floppy disk; a CDROM/RAM; a DVD ROM/RAM (including +R/RW,−R/RW); any form of magneto optical disk; a hard drive; a transmitted signal (including an internet download, file transfer, or the like); a wire; or any other form of medium.

### BRIEF DESCRIPTION OF THE DRAWING

There now follows, by way of example only, a description of a preferred embodiment of the present invention with reference to the following accompanying drawings, of which:

FIG. 1 shows a schematic layout for a typical computer system;

FIG. 2 shows a possible arrangement of a server, and access devices to provide the present invention;

FIG. 3 shows a schematic diagram of a system suitable for providing an embodiment of the invention;

FIGS. 4-6 show flowcharts of operations that may be performed by the system; and

FIGS. 7 to 13 show screen shots from one embodiment of the present invention.

### BRIEF DESCRIPTION OF THE PREFERRED EMBODIMENT

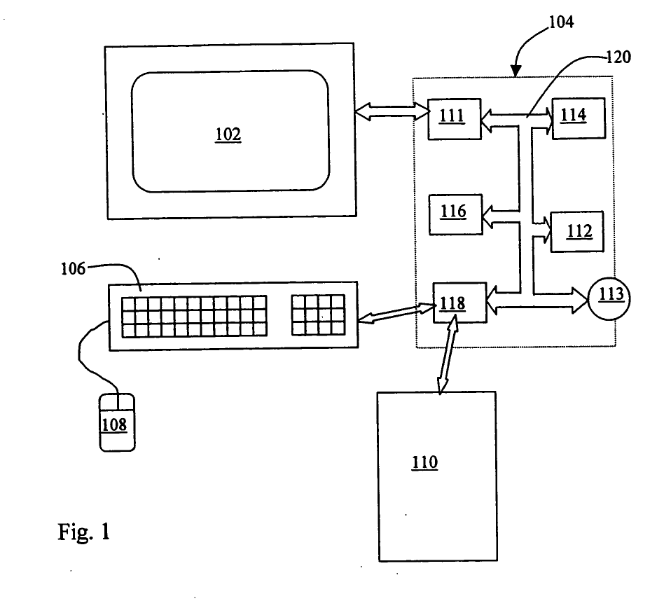

The system of the present invention is intended to be accessed by a user of a personal computer system, or terminal means, such as the system shown in FIG. 1. The personal computer 100 comprises a display 102, processing circuitry 104, a keyboard 106, a mouse 108 and a printer 110. The processing circuitry 104 comprises a display driver 111, a processing unit 112, an IP port 113 (which provides an access means), a hard drive 114, a memory 116, an I/O subsystem 118 and a system bus 120. The display driver 111, processing unit 112, IP port 113, hard drive 114, memory 116 and I/O subsystem 118 communicate with each other via the system bus 120, which in this embodiment is a PCI bus, in a manner well known in the art.

Such processing circuitry 104 may be provided by a number of different computer systems that are currently available. There is the architecture referred to a PC, which historically is based around the X86 range of processors produced by the INTEL™ Corporation. Other computer system such as those produced by APPLE™, or any other suitable system may be used.

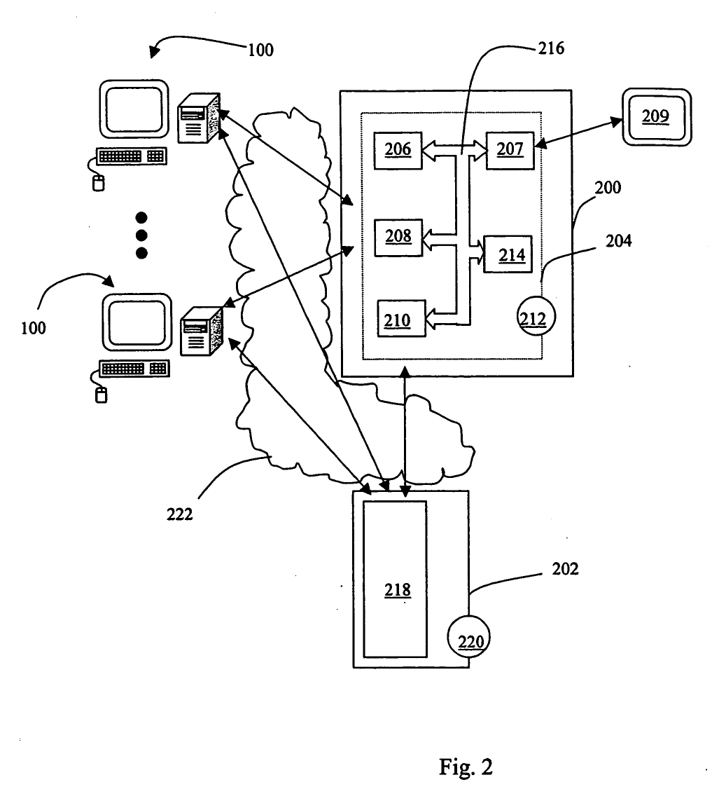

An arrangement of the system for providing the present invention is shown in FIG. 2. A server 200 is provided, but it will be appreciated that a plurality of interconnected servers could also be provided. A remote mass storage device 202 is also provided. The server 200 and the remote mass storage device 202 can be remotely accessed by personal computers 100. It will be appreciated that the server could be accessed by Personal Digital Assistants (PDA's), mobile computers, mobile telephones, or the like, but these will not be described further here.

The server 200 comprises processing circuitry 204 which comprises a number of sub components: a processor 206, a display driver 207 (arranged to drive a display means 209 such as a VDU, etc.), system memory 208, a local mass storage device 210 (in this case an array of hard drives), an IP port 212 and an Input/Output (I/O) controller 214. The sub components of the processing circuitry communicate with one another via a system bus 216.

The remote mass storage device 202 comprises a Redundant Array of Inexpensive Discs (RAID) array of hard drives 218, also comprises a server of the system, and which provides the storage for a number of documents, and an IP port 220.

The remote mass storage device 202 and the local mass storage device 210 may be thought of as mass storage devices for information accessible to users accessing the system of the present invention. In this example, the remote mass storage device 202 provides storage for electronic documents and the local storage device 210 provides storage for a database means 608, and for a diary system, or diary means. A user will access the database means 608 on the server 200 to discover the location of a particular document stored on the remote storage device 202 and can be provided with a network address thereto.

Each of the personal computers 100 can connect to the server 200 and to the remote mass storage device 202 using its IP port 113, the IP port 212 of the server 200, the IP port 220 of the remote storage device 202 using known TCP/IP connection protocols. The TCP/IP protocols will not be described further, but will be readily appreciated by the person skilled in the art. However, it will be appreciated that the connections are not directly between the computers 100 and the server 200, but via Internet Service Providers (ISP's) 222 (although direct connections are technically possible).

The server 200 of FIG. 2 will be accessed in two main ways under the system. The first is by a system administrator, who will use a ‘front-end’ software application to access, add to or amend data stored on the local 210 and remote 214 mass storage systems. In some embodiments amendments to the database are restricted or prevented to add to the security of the documents and as such once an electronic document is stored on the system it may be unalterable (this may satisfy monitoring bodies that the system may be used to hold legal documents). The system administrator will also maintain the diary system stored on the local storage system 210, which keeps track of the service history of each vehicle and provides reminders when a service is due. The user, who can make a connection thereto, and request data from the database means 608 held thereon. This connection would typically be through a computer 100 in their own home or office.

The database that is held on the local mass storage device 210 is, in this embodiment, provided by Microsoft™ Corporation Access 97™ database.

The Microsoft™ Corporation SQL Server 6.5™ provides a database engine. Requests for data stored in the database on the local mass storage device 210 from the user of a computer 100 are ‘translated’ into instructions in Structured Query Language (SQL), which is understood by SQL Server 6.5™. A suitable software application is required on the server 200 to allow the database to be accessed. Upon receiving a request for data, the database engine searches the database for the information required.

The data is then transmitted back though the IP port 212 of the server 200 to the IP port 113 of the computer system 100 requesting the data.

In one embodiment the diary system is provided by Kerridge Computer Company. However, the skilled person will realise that the diary system may be provided as a portion of the database means 608 or other program running on the processing unit 112.

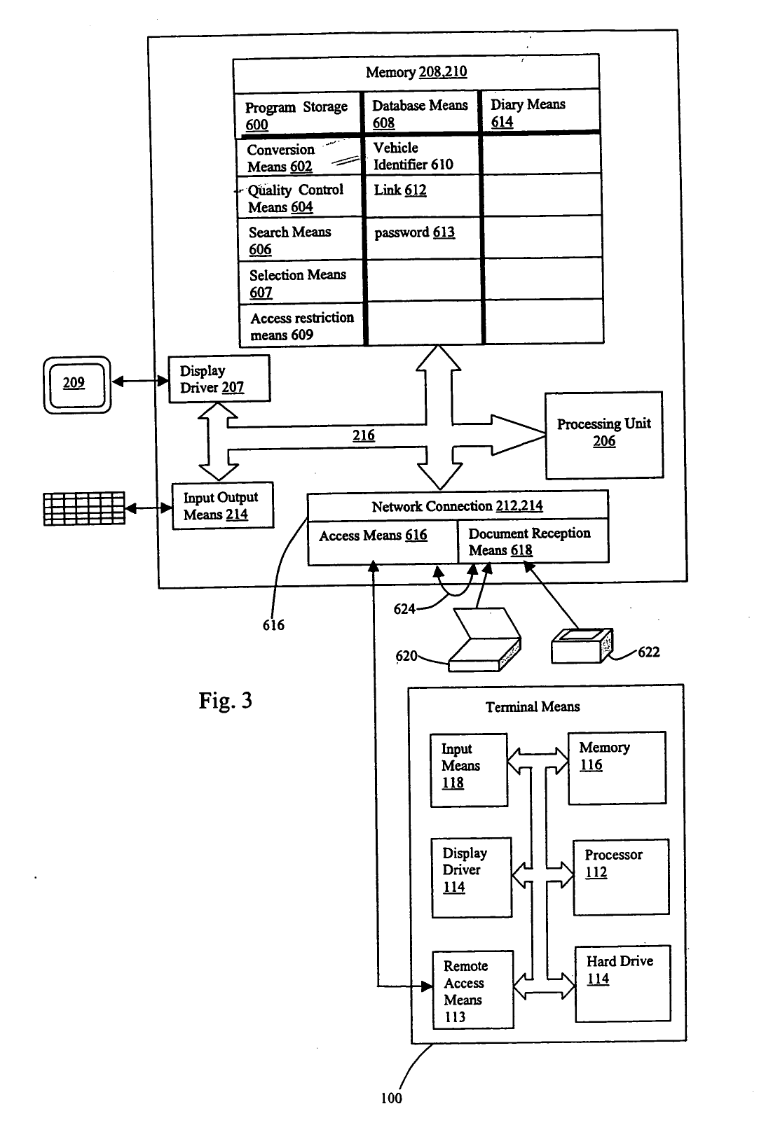

FIG. 3 shows an example of a system for realising an embodiment of the present invention which will now be described with reference to FIG. 1 for ease of understanding. The processing unit 112 communicates with a memory via the system bus 120. As the skilled person will appreciate, the memory may be provided by a variety of physical devices. For example the memory may be provided by a cache memory associated with the processing unit 112, a RAM memory of the processing circuitry 104, the hard disk drive 114, a remote storage connected to the processing circuitry 104 by the I/O subsystem 118 or maybe the IP port 113. However, in this embodiment the memory is provided by the hard drive 114 and RAM memory 116 of the processing circuitry 104 and may be temporarily cached in a cache memory of the processing unit 112.

A program storage portion 600 of the memory 114,116 is allocated to program storage and is used to hold program code that can be used to cause the processor to perform predetermined actions. In this embodiment, the program code includes a conversion means 602, a quality control means 604, a search means 606, a selection means 607 and an access restriction means 609. The functions of these blocks will be expanded upon hereinafter.

A database portion of the memory 114,116 is allocated to holding a database and provides a database means 608. In this embodiment the database includes fields that provide a vehicle identifier 610 and links 612. Again, the function of these portions of the database means will be expanded upon hereinafter.

The memory 114, 116 also comprises a diary means 614 and again, the function of the diary means will be expanded upon hereinafter.

The processing unit 112 can communicate with devices external to the processing circuitry via network connection means 616. The skilled person will appreciate that such network connection means 616 can comprise a variety of parts, but in the present embodiment is provided by the I/O subsystem 118 and the I/O port 113. The network connection means 616 further comprises an access means 618 which allows terminal means 100 to communicate with the processing unit 112.

The network connection means 616 also comprises a document receipt means 618 that is arranged to receive electronic documents thereto. The document receipt means 618 can receive such electronic documents from any source that is suitable for generating the document in the correct format. However, in this embodiment the document receipt means 618 is arranged to receive electronic documents from any of the following: a scanner 620, a fax machine 622, a network connection 624 to the processing circuitry 104.

As can also be seen from FIG. 3 the terminal means 100 is as shown in FIG. 1.

An example application of the present invention herein described is a system to make service documents relating to commercial rental vehicles readily available to the customers who rent them. However, the invention may have wider applicability and this embodiment is provided by way of example only.

The roadworthiness of vehicles used in the commercial vehicle rental industry (like that of all vehicles on the road) is carefully monitored by regulatory authorities. The government requires that every service vehicle has an associated operating licence, generally referred to as an O-licence. Any person wishing to run a fleet of service vehicles, for example refrigeration vans or haulage trucks, should hold an O-licence covering the vehicles in that fleet. The O-licence is originally granted following an inspection of the Vehicle Inspectorate of the resources available for servicing the vehicles of the fleet but may be revoked for failing a later ad-hoc inspection which reveals that the vehicles are not being maintained according to certain minimum standards. These standards may be, for example, that the vehicle holds a valid MOT or that it is serviced at least every six months.

When considering rented service vehicles, current legislation requires that a rental vehicle operator obtains an O-licence covering each vehicle in its fleet within twenty eight days of first hiring the vehicle The rental vehicle operator may be the rental company, the customer of that company or some other person. Under present industrial practice, the rental vehicle provider in this context is generally the person or company which supplies the driver of the vehicle.

In order to obtain an O-licence the rental vehicle operator may then be required to produce documents relating to the service history of a vehicle they do not own; i.e. the company owning the vehicle may be the company that hires the vehicle to the operator.

It is therefore highly beneficial to have immediate access to all documents proving that a vehicle meets statutory requirements. The system of the present invention provides access to the documents in the manner described below.

A unique identifier identifies each vehicle in the rental company's fleet and in this embodiment provides the data for the vehicle identifier field 610 of the database means 608. It is convenient to use the registration number of the vehicle, as displayed on the number-plate of each vehicle. The unique identifier is linked to a list of document locations. These links are held within the link database field 612 of the database means 608. The document at a particular document location is described by a title and is attributed with the date on which it was issued and, if applicable, an expiry date. The documents are categorised into one of four sub-categories: legal, maintenance, ancillary and other. Documents categorised as ancillary relate to additional, non-standard features of the vehicle, such as a tail lift, a crane or a refrigeration unit mounted thereon. Each document within these categories will generally be a standard document from the list displayed below:

| | Document | |
|---|---|---|
| Category | Type | Description |
| Legal | MOT | An annual general road fitness test |
| | | certificate. |
| | RFL | Issued as proof of road fund taxation |
| | | payment. |
| | V5 | Vehicle registration document issued by the |
| | | DVLA. |
| | Tachogragh | A 6-yearly test of the tachograph |
| | Calibration | calibration |
| | Tachograph | A 2-yearly recordal of the tachograph |
| | Check | reading |
| | Speed | Issued as proof of calibration and sealing |
| | limiter | after repair work carried out. |
| | Reduced | Issued as proof of engine emissions |
| | Pollution | conformity. Used for road fund taxation |
| | Certificate | rebates. |
| Maintenance | Intermediate | Safety inspection carried out to Ministry of |
| | Service/in- | Transport requirements to meet operator |
| | spection | licence requirements. |
| | Basic | Engine lubrication and preventative |
| | Service | maintenance checks. Incorporates |
| | | intermediate inspection. |
| | Annual | Full lubrication and preventative |
| | Service | maintenance checks. Incorporates |
| | | intermediate inspection. |
| Ancillary: | Weight test | Annual weight test certificate carried out to |
| Tail lift | | meet health and safety requirements. |
| | Service | Bi annual examination record sheet. |
| | Service & | Both annual weight test and bi-annual |
| | Weight test | examination carried out together. |
| Ancillary: | Weight test | Annual weight test certificate, carried out |
| crane | | to meet health and safety requirements. |
| | Service | Bi-annual examination record sheet. |
| | Service & | Both annual weight test and bi annual |
| | Weight test | examination carried out together. |
| Ancillary: | Service | Record sheet for fridge maintenance. |
| Fridge | | |

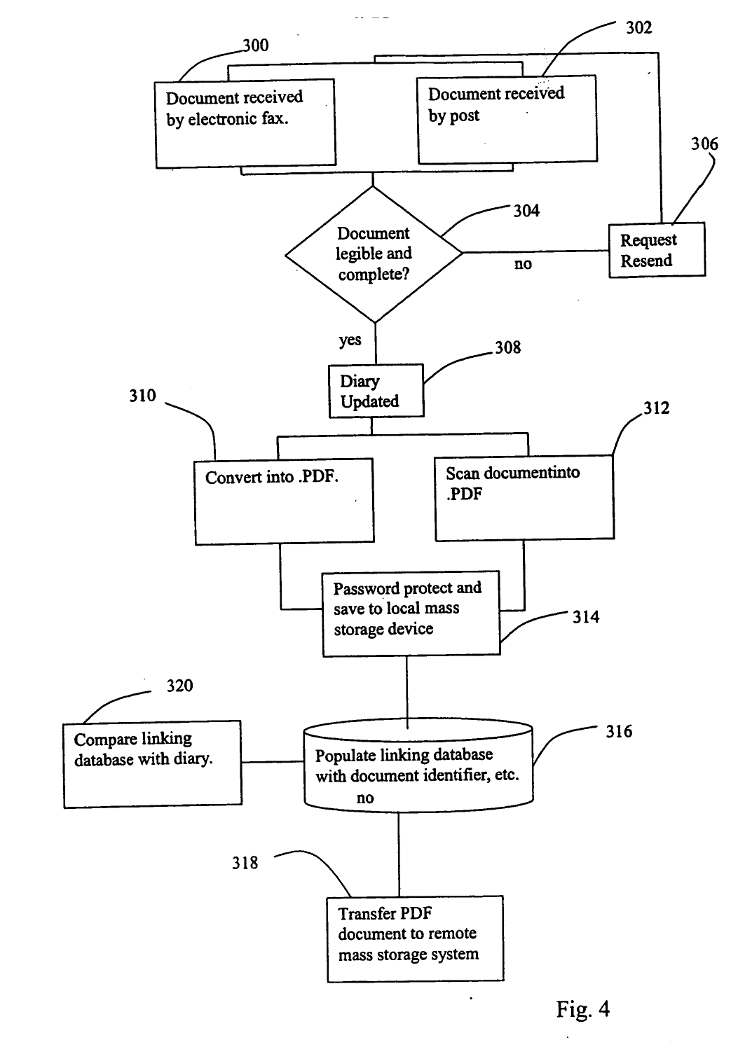

The first stage in providing an embodiment of the invention is for the system administrator to produce indexed electronic documents. A flow chart outlining the procedure for this is shown in FIG. 4 and comprises carrying out the following steps.

A document from the above table will generally be received from a garage that performed the work or from a regional office of the rental company either by electronic facsimile 300, which provides a document reception means, using a software package such as Zeta Fax™, produced by Equis Plc., or by post 302. Sending documents by electronic facsimiles comprises the sender sending the facsimile in the usual manner. The facsimile is then received not by a facsimile machine, but by a computer server which stores the electronic document (it will be appreciated that the facsimile provides an electronic document). Of course, other transmission mediums may be applicable, such as email, ftp (file transfer protocol), or any other suitable mechanism. The documents may never exist in paper form.

The document will then be checked for legibility and for completeness, step 304 using a quality control means, which in this embodiment comprises a mechanism for displaying the electronic document and an input to the system to indicate whether or not the document is acceptable. Alternatively, or additionally, the system may be arranged to automatically verify the electronic document. For example, it is possible to analyse the electronic document to ensure that it meets predetermined legibility criteria. For example if the document contains more than a predetermined number of incorrectly spelt words, has more than a predetermined percentage of the document that is not plain (i.e. more than a predetermined percentage is covered by ink), then it may be flagged as a document that needs further review or may be rejected.

Each document must have certain attributes to meet statutory requirements, some examples of which are shown in the table below.

| | Document | |
|---|---|---|
| Category | Type | Check |
| Legal | MOT | Registration No; Expiry date; Signature; |
| | | Test Station Number. |
| | RFL | Registration No; Expiry date; Vehicle |
| | | description, make and model; Gross |
| | | Weight. |
| | V5 | Registration No; Registered keeper; Vehicle |
| | | description, make and model; Gross Weight |
| | Tachograph | Registration No; Date; Signature; Agency |
| | Calibration | Seal Stamp. |
| | Tachograph | Registration No; Date; Signature; Agency |
| | Check | Seal Stamp. |
| | Speed | Registration no.; date; signature; agency |
| | limiter | seal stamp |
| | Reduced | registration no. date of expiry; signature. |
| | Pollution | |
| | Certificate | |
| Maintenance | All Service | Registration No; Date; Signature for |
| | Sheets | service; Signature for defects rectification; |
| | | Tacho date; mileage; Dealer stamp; Brake |
| | | Test reading, All Check Items |
| Ancillary | All | Registration No; Date; Signature; All |
| | Ancillary | Check Items |
| | services and | |
| | weigh | |
| | checks | |

If the document is unclear or if it is incomplete with respect to any of the requirements outlined above, a request will be sent to the garage or regional office that sent the document to the effect that the document should be resent—step 306 and/or re-scanned. It will be appreciated that such a request could be sent electronically (for an example an electronic communication such as an email could be generated by the processing means 206 and sent via the network connection means 212), by post or made over the phone. If the document meets all requirements, the diary system that keeps track of the service history of the vehicles will be updated to reflect that the service identified by the document has been carried out—step 308.

Under the system of the present invention, the electronic documents are made available over the Internet. An accepted standard format for documents available on the Internet is Portable Document Format (PDF). Any electronic document may be converted, using a conversion means 602 of the system, into PDF using Acrobat™, a software package produced by Adobe™ and viewable using the Acrobat Reader. If the documents were received via a facsimile, they are simply converted electronically into PDF by the conversion means 602—step 310. If they were received by post or in paper form, they must first be scanned by a document scanner 620 to produce an electronic document, which is then converted to PDF—step 312.

The electronic document (PDF document)—which is an electronic ‘image’ of the document—is then protected with a password to prevent it being manipulated and is saved on the local mass storage system 210—step 314.

The database means 608 stored on the local mass storage system 210 is then updated with a document identifier for the document and document attributes—e.g. document category and type—and also with an IP address-step 316. An IP address uniquely identifies the location of a document or resource available on the Internet. More specifically in this case, the IP address identifies the proposed location of the document.

The document is then stored on the remote mass storage system 202 as an internet-based ‘web page’ i.e. an electronic PDF version of the document is sent through the IP port 212 of the server 200 to the IP port 220 of the remote storage device 202 in step 318. Web pages will be familiar to those skilled in the art but briefly comprise storing the document in a storage location with a known IP address, unique to that document. The address may then be used to locate the document and is stored in the link field 212 of the database means 608.

The updated database means 608 may be compared to the diary system 614 to ensure that the service history as related in both of the diary system 614 and the database means 608 are identical—step 320. Any discrepancies can then be dealt with on an ad-hoc basis. The discrepancies may be brought to the attention of a user, perhaps via an electronic communication such as email, display on the display means 102,209.

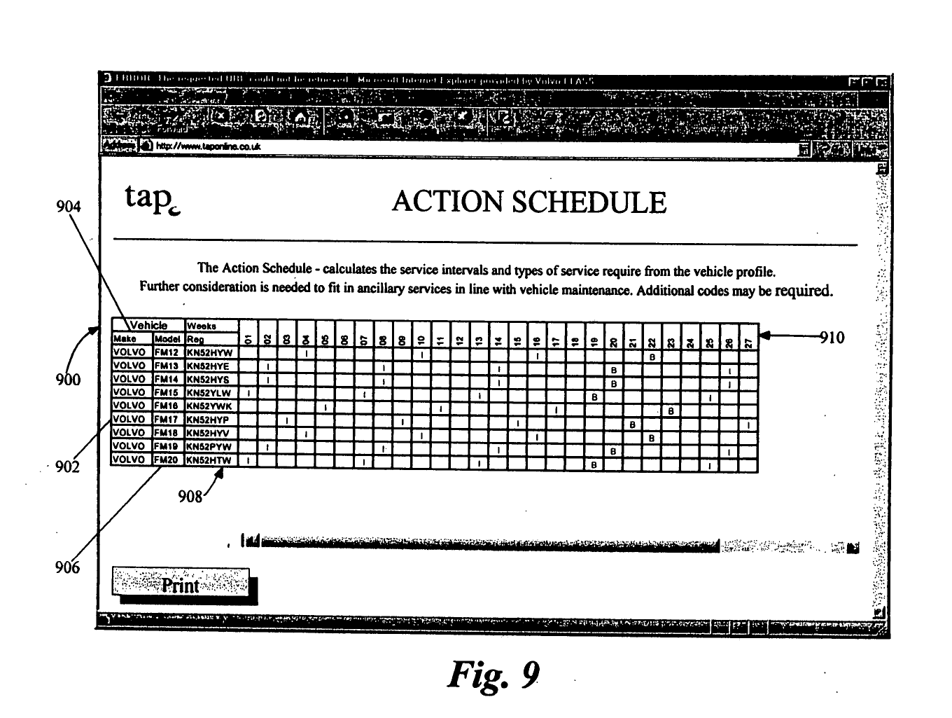

A screen shot for the diary means of one embodiment of the invention is shown in FIG. 9. It can be seen that in this embodiment the diary means is shown within a browser window 900 and contains a table 902. The table 902 contains a list of vehicles identified by their make 904, model 906 and registration number 908 (providing a vehicle identifier).

Along a top row 910 of the table there is provided a list of week numbers (the visible range in the Figure covering weeks 1 to 27 (i.e. roughly a six month span)). The vehicles monitored by the system shown in FIG. 9 have three types of service: an inspection, a basic and an annual service. In the Figure the inspections are represented by an “I” and the basic inspections by a “B”. There are no annual inspections shown. It will be seen that each vehicle is scheduled to have an inspection every six weeks, with a basic service every fourth service. Therefore, the diary means 614 keeps a record as to when the vehicle should be serviced.

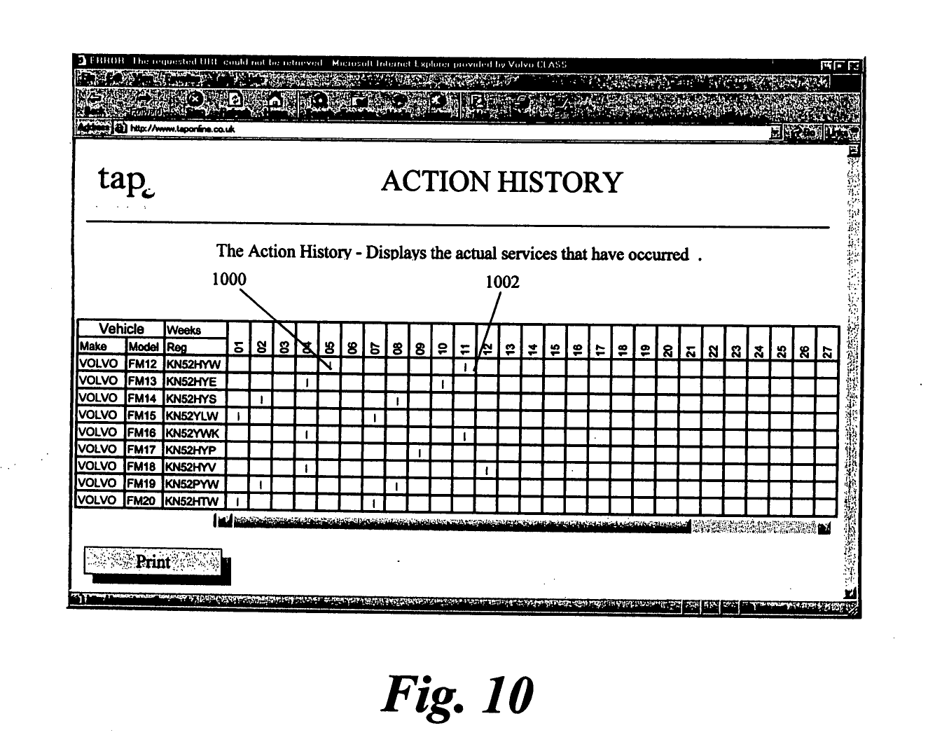

The diary means 614 as can be seen in FIG. 10 can also be used to record when a vehicle was actually serviced. The table of FIG. 10 is the same as that of FIG. 9 except that the table records when the vehicle was actually serviced rather than when it should have been serviced.

Therefore, it can be seen that the vehicle with registration KN52HYW was serviced in the 5th 1000 and 11th 1002 weeks.

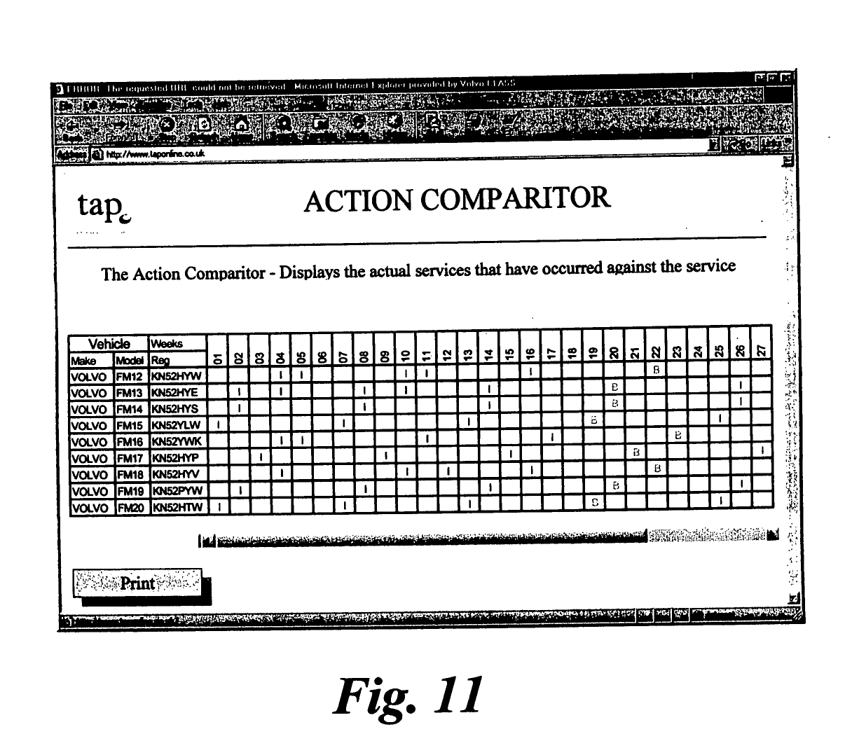

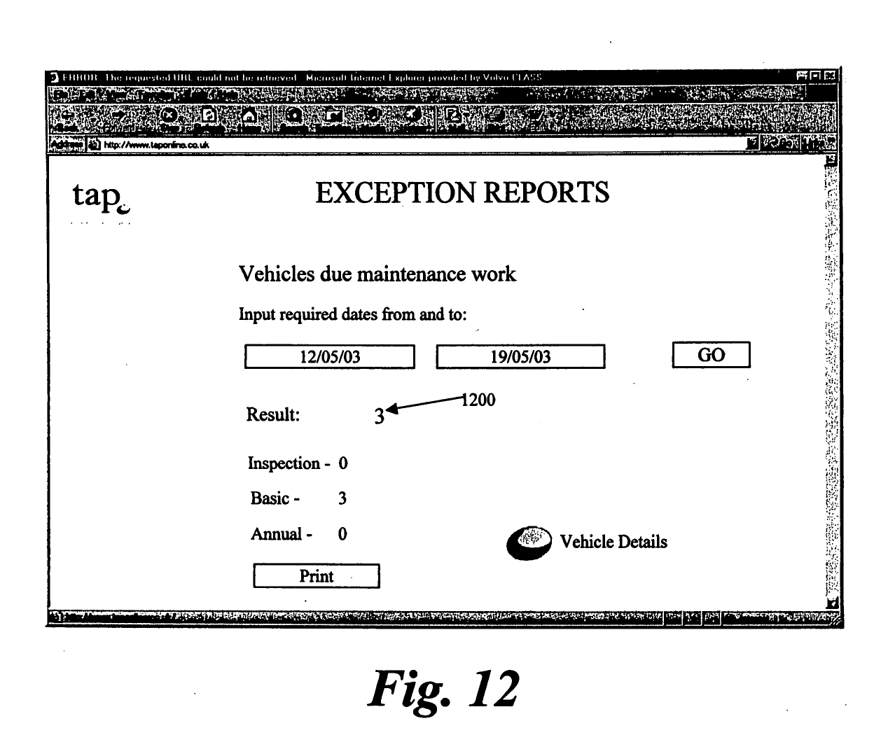

As can be seen from FIG. 11 the diary means 614 can also be used to generate a comparison as to when the vehicle should have been serviced and when it actually was serviced. This feature can be used to generate what may be termed exception reports; i.e. list vehicles that have not met the servicing requirements, have an outstanding service due, etc. An example of a screen showing this information is shown in FIG. 12 in which it is stated at 1200 that there are three vehicles with an outstanding service. In this example the service that is outstanding on the three vehicles are basic services and there are no inspections or annual services outstanding. Further, it will be appreciated from the Figure that the diary means allows a user to input a date range over which time the exception reports should be generated. In this example the reports are generated for the period May 12, 2003 to May 19, 2003.

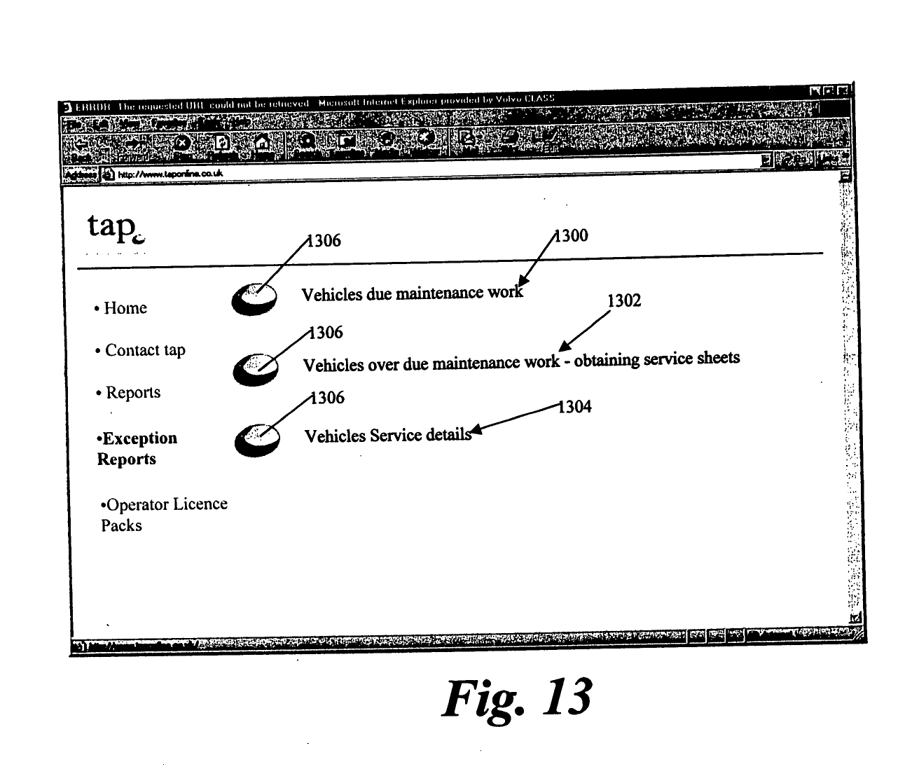

A screen such as that shown in FIG. 13 may allow a user to view whether he/she wishes to see which vehicles are due for a service 1300; are overdue a service 1302; and to actually see the service history of a vehicle 1304. The three functions are accessed by pressing the buttons 1306 using the GUI (Graphical User Interface) on which the software is run. The first option (vehicles are due for a service 1300) takes a user to FIG. 9; the second option (overdue a service 1302) takes a user to the screen shown in FIG. 10; and the third option (service history of a vehicle 1304) takes a user to the screen shown in FIG. 11.

Embodiments of the system are generally arranged such that when a service document is received by the system then the service record for that vehicle is automatically updated by the system.

The vehicle identifier field 610 of the database may include a fleet sub set identifier that identifies that particular vehicle as belonging to a subset of the vehicles held in the database means 608. For example the subset identifier may identify that vehicle as belonging to a fleet of vehicles which may be owned by the same company as one another.

In this particular embodiment the database means 608 holds documents relating to vehicles from a plurality of fleets. However, each subset of vehicles (i.e. the vehicles of a particular fleet) are protected by a password 613 which is held in the database. The access restriction means 609 prevents access to the documents for a vehicle from a particular fleet unless the correct password 613 has been supplied.

In alternative, or additional, embodiments a separate database may be provided for each of the subsets of vehicles.

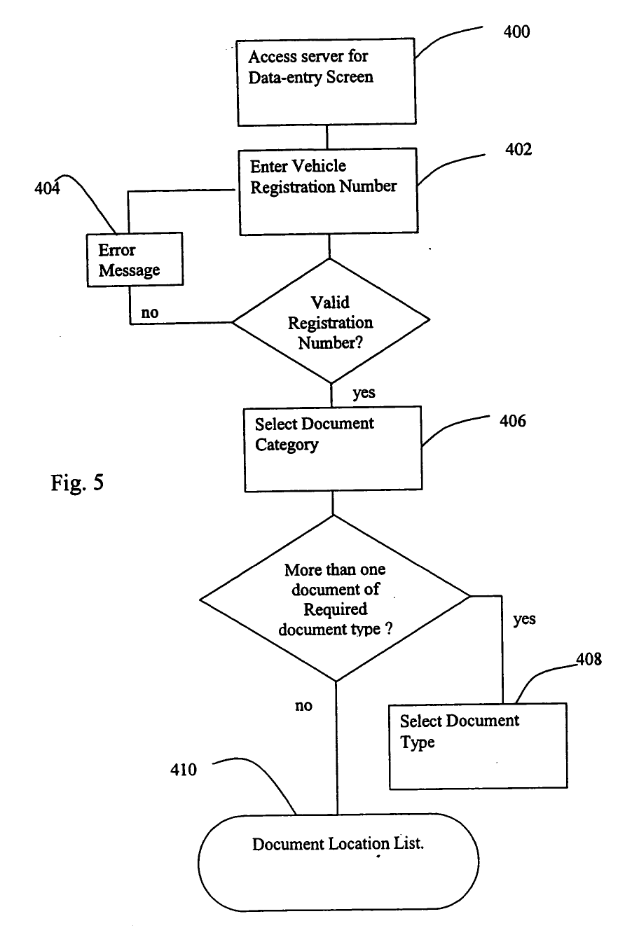

With reference to FIG. 5, a user wishing to access the location of a particular document will have to undergo the following steps.

The user uses the IP port 113 of his/her terminal means or computer system 100 to access the database means 608 provided on the server 200. The processing circuitry 106 will receive inputs from the IP port 212 of the server 200 and will cause the screen 102 to display a data-entry sheet-step 400 (providing an input to the search means 606). The user makes an input using the keyboard 106 onto the data-entry sheet—step 402. The input comprises the registration number of the vehicle for which information is required. This input will be transmitted via the IP port 113 of the computer system 100 to the IP port 212 of the server 200 and the processing circuitry 204 of the server 200 will cause the vehicle identifier field 610 of database means 608 to be accessed by the search means 606 to provide data concerning the vehicle identified by its registration number (providing that the registration number is valid. If this is not the case, an error message 404 will be displayed on the screen 102).

Once the search means 606 has located a valid vehicle identifier field 610 then an associated link field 612 from the database means 608 is used to locate documents for that vehicle. Initially, the screen 102 will display a list of the four sub-categories. The user will have to identify under which category the document of interest will be stored. The user makes an indication of his/her choice to the selection means 607 by using the mouse 108 to position a pointer on the screen 102 over the chosen category as it is displayed on the screen 102 and by ‘clicking’ a button on the mouse in a manner familiar to those skilled in the art—step 406. A list of document types will then be displayed and the electronic documents are therefore grouped according to the sub-category in which they have been placed. If there is more than one document of any of the types listed in the above table, the user again makes an indication of his/her choice of document type by using the mouse 108 to position a pointer on the screen 102 over the chosen document type as it is displayed on the screen 102—step 408. The user will then be presented with a list of document locations that include the IP address of the desired document 410. The IP address is generally provided as a link that can be selected by a user—with the IP address then being obtained using name servers, etc. as will be appreciated by the skilled person.

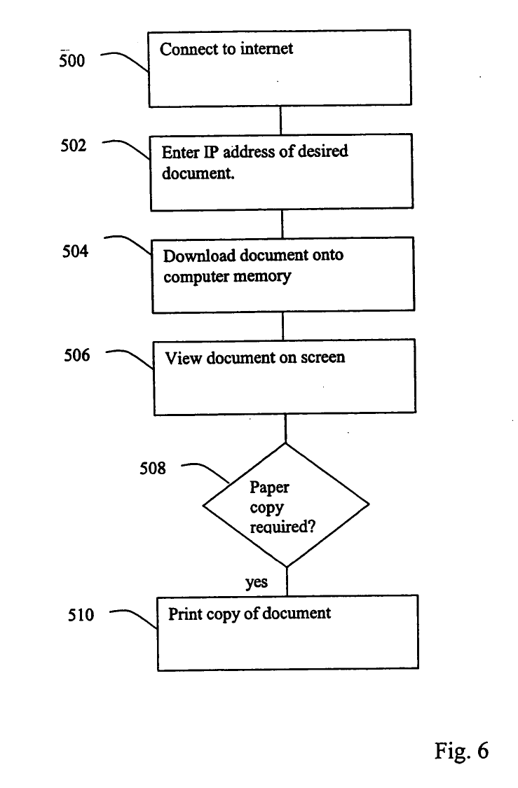

Once provided with this list, the user may then access the remote storage device 202 and locate the desired document by activating a link. The procedure followed is outlined in FIG. 6, but it will be appreciated by those familiar with the Internet that the list of addresses may be provided as a ‘hyperlink’. The processing circuitry 104 may then be provided with the IP address in the following simple manner. The mouse 108 is used to position a pointer on the screen 102 over the chosen hyperlink as it is displayed on the screen 102, and a button on the mouse 108 clicked. Alternatively, the IP address may be typed into a ‘web browser’ using the keyboard 106.

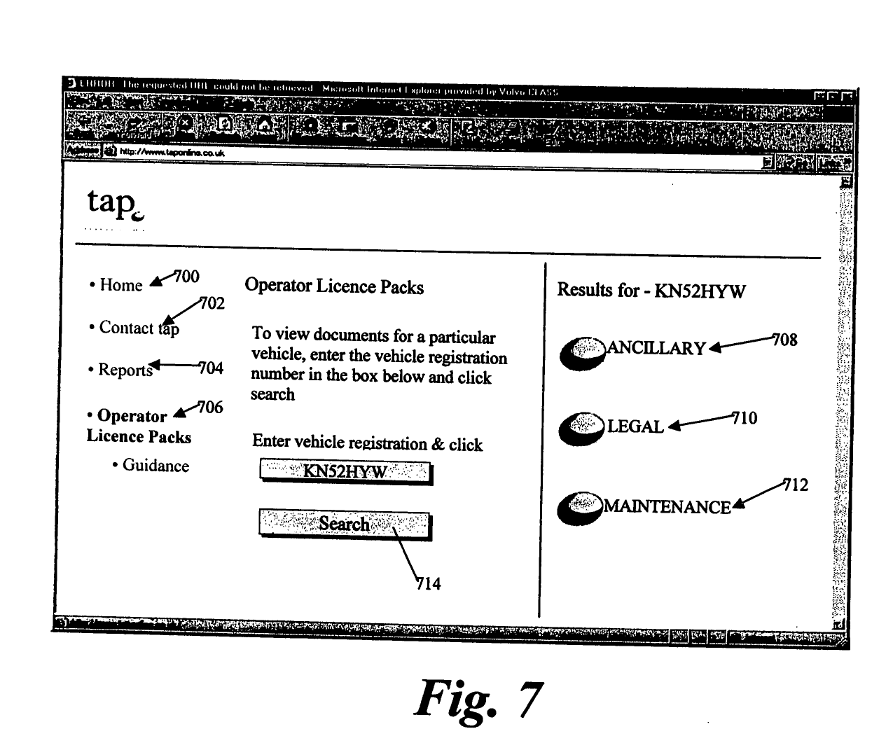

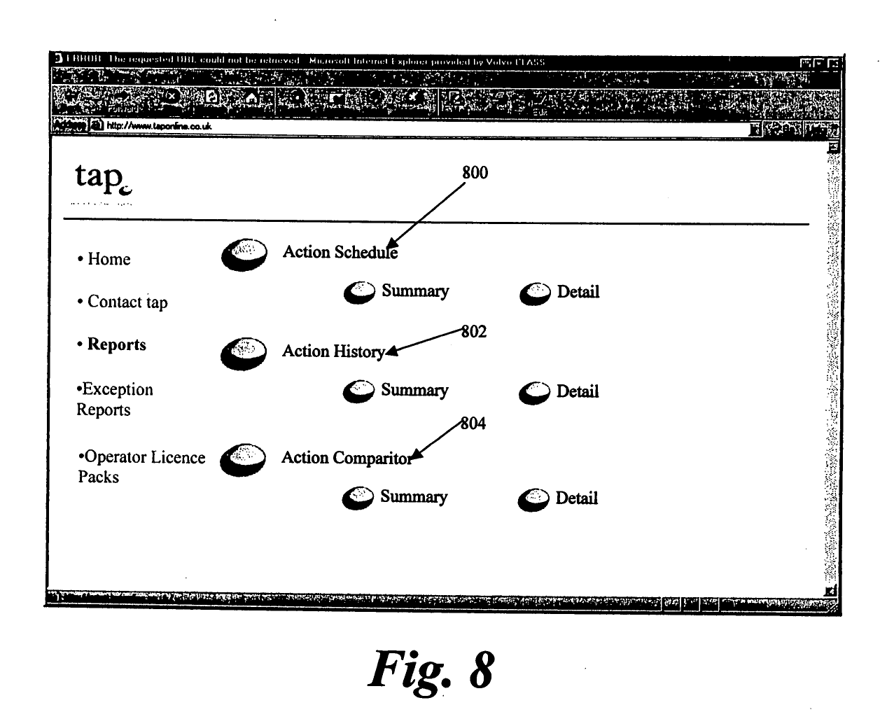

Example screens of what may be shown to a user to allow them to access data on the system is shown in FIGS. 7 and 8. At the left hand side of the screen, as shown in the Figure, four links are provided (home 700; contact 702; reports 704; and operator licence packs 706). The operator licence packs 706 allows a user to view the licence documents and is the screen shown in FIG. 7. The right hand side of the screen shows that for a particular vehicle (having vehicle identifier KN52HYM) there are documents relating to ancillary features 708, legal documents 710 and also the maintenance record 712. A search button 714 is provided should a user wish to search for information on another vehicle. The options 708,710 and 712 allow a user to view copies of the actual documents for the vehicle.

The contact link 702 shows the contact details for contacting the provider of the system.

The reports link 704 takes a user to the screen shown in FIG. 8 which provides an action schedule 800; and action history 802 and an action comparator 804. A detailed and a summary view button is provided for each. The summary view of the action schedule is shown in FIG. 9. The summary view for the action history is shown in FIG. 10 and the summary view for the action comparator is shown in FIG. 11.

The user connects to the Internet using TCP/IP protocol through its IP port 113—step 500. The user then enters the IP address of the desired document (step 502) (generally using a www address which corresponds to the network address and as interpreted by a name server) and the processing circuitry 104 requests data from the remote storage means 202 through its IP port 220 which is then sent through the IP port 220 of the remote storage means 202 to the IP port 113 of the user's computer 100, step 504. This is generally referred to as ‘downloading’ the document.

The document is then displayed on the screen 102 of the user's computer-step 506. The user may decide to produce a paper copy of the document (step 508). It may be required to carry documents relating to the vehicle in use of the vehicle. In this case, an input can be made using the mouse 108 or the keyboard 106 to the processing circuitry 104 instructing that the document should be printed using the printer 110.

Although it is advantageous to get the documents on to the system as soon as possible it is conceivable that there may be a delay. In a possible embodiment, the documents are not added to the system as and when they are received but are included in a daily ‘data feed’. The system may be capable of receiving and interpreting data feeds (a data feed comprises a data file with a set format, which may be sent over the Internet or input into the server 200 in some other way.). The data feed need not be daily and could equally be weekly, bi-weekly, monthly or at some other interval.

The system is also arranged to generate reports of service histories of all vehicles held on the system. These reports can be generated for any predetermined length of time, but in one embodiment this is annually. Such reports provide a much greater accountability than prior art systems. The reports may highlight discrepancies between the diary means and the database means, or may simply provide analysis of one or both of the diary and database means. This feature is provided by the diary means as described above in relation to FIGS. 9 to 13.

Further, the system allows the service histories to be maintained with the generation of less paper work than prior art systems, and can allow events to be tracked much more readily. Therefore, the system provides greater accountability/traceability.

Further, because each servicing performed on a vehicle is detailed within the system, the system makes it easier to comply with legislation in which the system is based. Such legislation includes vehicle safety regulations provided by the Driver and Vehicle Licensing Agency (DVLA) and the Vehicles Inspectorate.

As storage space on the Internet is at a premium, it may be required that data that is no longer relevant be ‘archived’. Such documents could include an MOT certificate more that a year old or documents relating to vehicles that are no longer on the road. Under the system of the present invention, this comprises removing the electronic document from the remote storage device 202 and removing the associated entry in the database means 608 on the server 200.

The skilled person will appreciate that the frequency with which the archiving system is employed depends in part on the capabilities of the remote mass storage device 202 and the number of documents held. For example, daily, monthly or quarterly archiving may be appropriate. Data back ups of some description are also advisable.

Although the system and methods described herein have been described in relation to vehicles and in particular the tracking of documents relating to a vehicle, the system could advantageously be applied to other things. In particular, the system may be advantageously applied to any apparatus that required periodic safety checking. An example of such apparatus is electrical apparatus in a working environment which may have to undergo annual earth leakage tests.

1. A document storage system arranged to store at least one electronic document comprising:
at least one server comprising a database means capable of storing documents and on which at least one electronic document is held within at least one database means;
document reception means capable of receiving documents and storing documents on the server, the document reception means being arranged to receive said electronic document and store said electronic document on said server within the at least one database means;
quality control means capable of allow quality control checks of said electronic document to be carried out;
access means capable of providing remote access to the server and arranged to provide such access;
search means capable of searching the database means and arranged to allow said electronic document to be located within the database means on said server;
terminal means arranged to allow users to connect to said server using said access means, locate said electronic document using said search means, and receive said electronic document; and
a diary means capable of maintaining data and receiving inputs from the database means the diary means being arranged to maintain a record of when at least one predetermined event occurs, which diary means is interfaced with the database means such that an input indicative that completion of the predetermined event is made to the diary means when a predetermined document is added to the database means.

2. The system according to claim 1 which is arranged to store electronics documents relating to vehicles and most preferably in relation to vehicles that are intended to be hired.

3. The system according to claim 1 in which the access means provides access to a network.

4. The system according to claim 1 in which document reception means is capable of receiving documents by fax.

5. The system according to claim 1 in which the document reception means is capable of sending documents is arranged to send documents received thereby to the server without generating a paper, or other hard copy.

6. The system according to claim 1 in which the document reception means comprises any one or more of the following: a facsimile machine, a scanner, a photocopier.

7. The system according to claim 1 in which the server is arranged such that the electronic document stored on the or each server is write-protected so that it requires a password to alter.

8. The system according to claim 1 in which the quality control means comprises a display means capable of displaying data which is arranged to display electronic documents received by the document reception means.

9. The system according to claim 1 in which the search means is capable of generating data and is arranged to generate a list of electronic documents that are available for a given search input thereto.

10. The system according to claim 9 in which the search means is arranged to group the electronic documents within the list into sub-categories.

11. The system according to claim 1 in which the search means is arranged to have input thereto an identifier for a vehicle.

12. The system according to claim 1 in which the diary means is arranged to monitor when vehicles must be serviced, tested, and the like.

13. The system according to claim 1 in which the database means is capable of generating data and is arranged to generate and/or maintain a link to an electronic document stored on the or each server.

14. The system according to claim 1 which comprises an archiving means capable of moving/deleting data and arranged to delete and/or archive electronic documents that have reached a predetermined age.

15. The system according to claim 1 which is arranged to generate pages viewable on a network as the page is required.

16. A method of storing an electronic document, said method comprising creating at least one electronic document, receiving said electronic document using a document reception means; checking the quality of the received electronic document using a quality control means; noting the arrival of the document using a diary means; storing said electronic document in a database means on at least one server; interfacing the diary means with the database means such that completion of a predetermined event is noted when a predetermined document is added to the database; allowing said electronic document to be located on said server by users of terminal means connected to said server via an access means and using a search means provided to facilitate the location of said electronic document.

17. A method according to claim 17 which stores documents that relate to one or more vehicles and most preferably in relation to vehicles that are intended for hire.

18. A machine readable medium providing instructions such that when loaded onto a computer system, the computer system functions according to claim 1.

19. A machine readable medium providing instructions such that when loaded onto a computer system, the computer system provides the method of claim 17.

20. A server arranged to track the status of one or more vehicles that is intended for hire; said server comprising a database means capable of storing documents and being provided with a means capable of receiving documents and arranged to receive an electronic document relating to one or more of said vehicles for storage thereon; said server further comprising access means capable of providing access to the server arranged provide access to said electronic document thereon from a remote source; said server further comprising a search means, or providing access to a search means, which facilitates the location of said electronic document, said server further comprising a quality control means capable of facilitating quality control checks of said electronic document and a diary means capable of receiving and maintaining data, and arranged to maintain a record of when at least one predetermined event occurs, which diary means is interfaced with the database means such that completion of the predetermined event is noted when a predetermined document is added to the database means.

21. A terminal means suitable for accessing a server according to claim 21.

22. A system arranged to track the status of at least one item of apparatus comprising a document storage means arranged to store at least one document, said system further comprising:
one or more servers capable of holding data, on which at least one electronic document is held;
a document reception means, capable of receiving a facsimile transmission and, arranged to receive said electronic document via a facsimile transmission and store said electronic document on said server;
a quality control means facilitating quality control checks of said electronic document;
access means capable of providing remote access to said server;
a search means arranged to facilitate location of said electronic document on said server, said search means being arranged to locate any electronic documents relating to a vehicle specified to said search means stored on the or each server;
a diary means capable of maintaining data and arranged to maintain a record of when at least one predetermined event in a occurs, which diary means is interfaced with the database means such that completion of the predetermined event is noted when a predetermined document is added to the database means;
terminal means capable of sending, receiving and displaying data arranged to connect to said server using said access means, and further arranged to receive a list of electronic documents relating to the vehicle specified to the search means;
selection means allowing a user to select one or more electronic documents from said list, and the system further being arranged for said terminal means to display said electronic document selected by said selection means.

23. A method of tracking the status of at least one item of apparatus intended for hire, the method comprising storing at least one document to facilitate the hiring of a vehicle, said method comprising:
receiving an electronic document using a document reception means capable of receiving a facsimile transmission;
checking the quality of the received electronic document using a quality control means;
noting the arrival of the received electronic document using a diary means;
one terminal means capable of allowing a user to access the memory using said access means, locate an electronic document using the search means and receive the electronic document on the terminal means, said server further comprising a quality control means capable of facilitating quality control checks of said electronic document and a diary means arranged to maintain a record of when at least one predetermined event occurs, which diary means is interfaced with the memory such that completion of the predetermined event is noted when a predetermined document is added to the memory.

24. The system according to claim 25 in which document reception means is capable of receiving documents by fax.

25. The system according to claim 25 in which the server is arranged such that the electronic document stored on the or each server is write-protected so that it requires a password to alter.

26. The system according to claim 25 in which the diary means is arranged to monitor when vehicles must be serviced, tested, and the like.

27. A computer program capable of controlling computing apparatus and arranged to maintain a database means of electronic documents, receive further electronic documents from a document reception means and store the received documents in the database means, provide a quality control check of the document using a quality control means, provide remote access to the database means and allow users to search the database means to locate electronic documents therein and forward them to the user, provide a diary means, and interface the diary means with the database means such that the completion of a predetermined event is noted when a predetermined document is added to the database means.

28. A computer program capable of controlling computing apparatus and providing an apparatus status tracking system, comprising a vehicle document storage and retrieval system, arranged to maintain a database means of electronic documents, receive further electronic documents from a document reception means and store the received documents in the database means, provide a quality control check of the document using a quality control means, provide remote access to the database means and allow users to search the database means to locate electronic documents therein and forward them to the user, provide a diary means, interface the diary means with the database means such that the completion of a predetermined event is noted when a predetermined document is added to the database means.

29. A database comprising a plurality of electronic documents relating to a vehicle, each document being password protected in order to prevent alteration thereof, and the database further comprising a diary means capable of maintaining data and arranged to maintain a record of when predetermined events are due to occur to the vehicle to which the electronic document relates and also maintain a record of when the event actually occurs.

30. A machine readable medium providing instructions such that when loaded onto a computer system, the computer system functions according to claims 25.

31. A machine readable medium holding instructions that provide the program of claim 29.

32. A machine readable medium holding data that provides the database of claim 31.

33. An apparatus tracking system arranged to monitor the status of at least one piece of apparatus, the system being arranged to store document data corresponding to at least one electronic document relating to the at least one piece of apparatus, the system comprising:
a document reception means arranged to receive document data providing the at least one electronic document and store the document data in a memory of the system after a quality control means provided by the apparatus has verified the quality of the document data;
a search means arranged to allow a user to search the document data in order to locate an electronic document;
the system being arranged such that the document data is accessible from a terminal means connected to the memory by an access means, the system being arranged such that a user of a terminal means can use the search means to search the document data and receive document data on the terminal in order to obtain a copy of a document; and
the system being further arranged to process the document data to maintain a diary means provided by the system, the processing of the document data being such that when predetermined document data is not received by the document reception means within a predetermined period of time of the time at which the predetermined event is expected to occur then feedback is generated, on the terminal means, to alert a user to the status of the apparatus to which the document provided by the document data relates.
